(19) United States
(12) Patent Application Publication
(10) Pub. No.: US 2010/0046699 A1
(43) Pub. Date: Feb. 25, 2010

(54) FLUOROSCOPY INSTALLATION

(75) Inventor: Martin Muenker, Grevelsberg (DE)

Correspondence Address: DARBY & DARBY P.C., P.O. BOX 770, Church Street Station, New York, NY, 10008-0770, US

(73) Assignee: YXLON International X-Ray GmbH, Hamburg (DE)

(21) Appl. No.: 12/524,638

(22) PCT Filed: Jan. 9, 2008
(86) PCT No.: PCT/EP08/00120

§ 371 Date: Jul. 27, 2009

(30) Foreign Application Priority Data
Jan. 29, 2007 (DE) 10 2007 004 365.3

(51) Int. Cl. H05G 1/02; G01N 23/00

(52) U.S. Cl. 378/42; 378/208; 378/205

(57) ABSTRACT

A system for moving a test object for a fluoroscopy unit includes a test carriage configured to be fixable to the test object and a guide element rotatable about a rotational axis, wherein the test carriage is configured to move along the guide element in a direction extending radially from the rotational axis.

The invention relates to a system for moving and fixing a test carriage within a fluoroscopy unit and to a fluoroscopy unit having an X-ray source and a detector which has such a system for moving and fixing the test carriage.

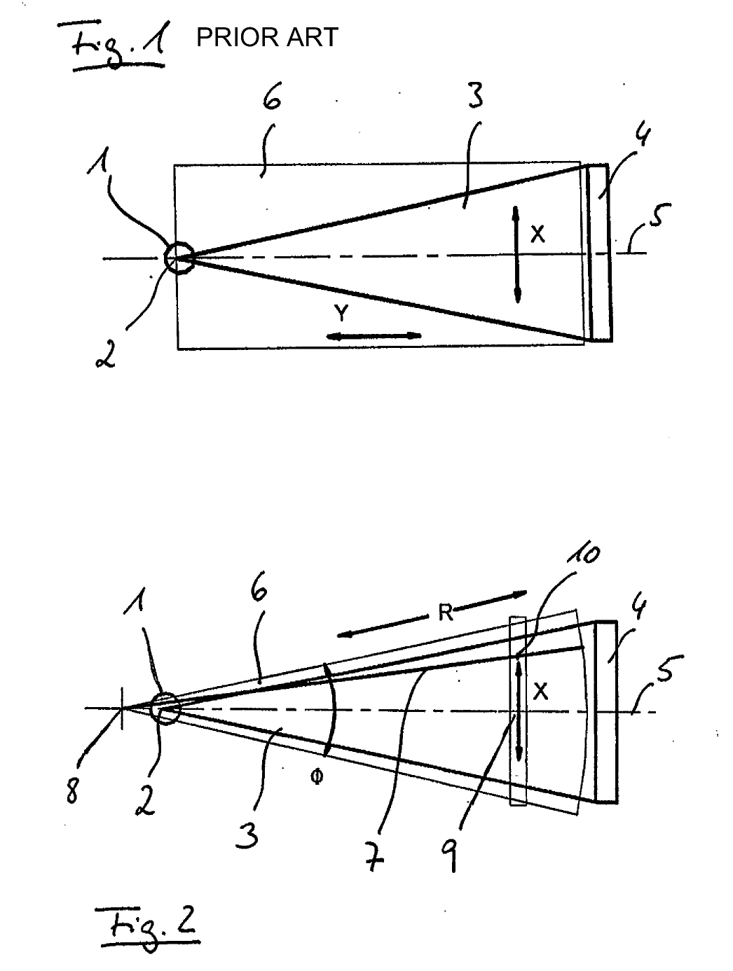

Fluoroscopy units such as are shown in FIG. 1 are known. By fluoroscopy units is meant within the framework of this application all units which examine a test object by passing X-rays through it and record the fluoroscopic image, in particular by means of radiography or CT technology processes. The fluoroscopy unit in FIG. 1 has an X-ray source 1 with a focal spot 2. Opposite this is a detector 4 which is completely illuminated by a ray fan 3 which starts from the focal spot 2 of the X-ray source 1. The central beam of the ray fan 3 is perpendicular to the surface of the detector 4, with the result that a centre axis 5 formed as an axis of symmetry is formed by it. To move a test object, there is a test carriage on which such a test object can be fixed. The test carriage can be moved along two axes perpendicular to each other, the Cartesian coordinates x and y, between focal spot 2 and detector 4. A range of movement 6 is covered by the respective end-points of the movement along the Cartesian coordinates x and y. This movement range is rectangular when the directions of movement are perpendicular to each other. Depending on the application, a positioning near the X-ray source 1 or the detector 4 is advantageous. The closer the test object is to the X-ray source 1, the greater the magnification. Positioning in this range must be very accurate in the case of short paths. The closer the object is to the detector 4, the longer the necessary paths, wherein, however, the positioning can also be carried out there with a lower degree of accuracy. The known Cartesian formation of the movement system can make no difference in respect of the necessary accuracy of the positioning, although a highly accurate positioning would be necessary for only a small part of the range of movement. This results in an expensive design, limitations in the selection of suitable mechanical components and an increased outlay on installation and fine adjustment, each of which entails higher costs.

The object of the invention is therefore to present a system for moving and fixing a test carriage of a fluoroscopy unit or a complete fluoroscopy unit which has a simpler mechanical structure but meets the requirements of high accuracy in the area near to the tubes.

The object is achieved by a system for moving and fixing a test carriage of a fluoroscopy unit with the features of claim 1 and a corresponding fluoroscopy unit with such a system with the features of claim 9. According to the invention, the test carriage is moved along and fixed to a guide element. The guide element is rotatable about a rotational axis. The test carriage thus moves in a radial direction along the guide element and performs a rotational movement when the guide element rotates about the rotational axis. This could also be called a “polar formation” of the system instead of the Cartesian arrangement known from the state of the art. The test object is fixed to the test carriage in a known way. The device according to the invention has the advantage that in the vicinity of the X-ray tubes the required high degree of accuracy obtains in the case of short strokes without the need to build in a very expensive long-stroke, highly accurate positioning unit known from the state of the art.

An advantageous development of the invention provides that the rotational axis is formed at one end of the guide element. In the normal application case, movement beyond the rotational axis is not necessary, with the result that for the sake of simplicity the “projecting” part of the guide element, which would only lead to a greater design outlay, can be dispensed with.

A further advantageous development of the invention provides that there is a first motor for the radial movement and a second motor for the rotational movement. By using one motor each for the radial movement and for the rotational movement, a complete decoupling of the two movements from each other is achieved. The use of separate motors obviates the need for an expensive transmission system.

Particularly preferably, the guide element is formed as a linear unit. The test carriage can be moved and fixed particularly easily on a linear unit. Such linear units are known to be very reliable and attractively priced from the state of the art. A linear unit is a “ready-to-install” assembly which has a support, a guide, a drive element and a seat for the carriage.

A further advantageous development of the invention provides that the rotational movement is performed via a transverse guide which cooperates with the guide element. In this case, it is particularly preferred that the transverse guide has a linear unit, in particular a straight guide rail, in which a connecting element movable in radial direction and attached to the guide element engages. It is thereby possible to also perform the rotational movement by means of a straight, linear movement. This makes for great mechanical simplicity.

Particularly preferably, the connecting element in this case is formed as a tilt-resistant rotational connection. The axis of rotation of the turntable is thereby exactly perpendicular to the ray fan in every position, since the axes are prevented from tilting towards each other by this rotational connection.

An advantageous development of the fluoroscopy unit according to the invention provides that the rotational axis is arranged on the centre axis between the focal spot and the centre of the detector. A symmetrical structure and a symmetrical movement of the test carriage in the fluoroscopy unit are thereby made possible, which clearly reduces the extent of the mechanism and thus the outlay.

A further advantageous development of the fluoroscopy unit according to the invention provides that the position of the rotational axis along the centre axis can be altered, in particular can be shifted along and fixed to it. It is thereby possible to fix the rotational axis in respect of the focal spot of the X-ray tube at different positions, depending on which possible use with the respective magnification and mapping geometries starting from it is needed. A very flexible fluoroscopy unit is thus obtained which can be adapted to a wide range of different applications. Particularly preferably, the rotational axis is arranged at the site of the focal spot.

A further advantageous development of the fluoroscopy unit according to the invention provides that the position of the transverse guide along the centre axis of the unit can be altered, in particular can be shifted along and fixed to it. The accuracy of the movement, its speed and the cross-stroke achievable overall can be influenced via the position of the transverse guide. Particularly preferably, the transverse guide is attached close to the detector.

A further advantageous development of the fluoroscopy unit according to the invention provides that the transverse guide is perpendicular to the centre axis between the focal spot and the centre of the detector. Such a design also aids the symmetry of the fluoroscopy unit in respect of the centre axis which extends from the focal spot to the centre of the detector. In addition, only a small outlay on control means is needed.

An alternative advantageous development of the fluoroscopy unit according to the invention provides that the transverse guide is not perpendicular to the centre axis between the focal spot and the detector. A dead point is thereby avoided in the central position for the radial connection, with a reduction in the risk of tilting and a possible interaction caused by the reversal of the direction of movement. This reversal point is displaced from the centre position by a non-perpendicular arrangement. It preferably lies at the edge of the range of movement, wherein the transverse guide is perpendicular to one of the two boundaries of the ray fan.

A further advantageous development of the fluoroscopy unit according to the invention provides that the transverse guide is attached asymmetrically to the centre axis. This results in unequal side-strokes, starting from the centre axis. It is thus possible for example to move the test object completely out of the beam path towards one side for calibration measurements.

Further details and advantages of the invention are explained in more detail using the embodiment example shown in FIG. 2. There are shown in:

FIG. 1 a schematic top view of a fluoroscopy unit according to the state of the art and

FIG. 2 a schematic top view of a fluoroscopy unit according to the invention.

Unlike the state of the art according to FIG. 1, the system according to the invention for moving and fixing a test carriage in the fluoroscopy unit according to the invention shown in FIG. 2 operates according to a completely different movement principle.

The schematic top view of the fluoroscopy unit according to the invention shows an X-ray source 1 with a focal spot 2. X-radiation in the form of a ray fan 3 emanates from the focal spot 2. This completely illuminates a one-dimensional detector 4. Instead of the ray fan 3, a ray cone can also be assumed which completely illuminates a two-dimensional detector 4. Starting from the focal spot 2, a centre axis 5 which is perpendicular to the detector 4 is drawn as a broken line. This centre axis 5 forms the centre of symmetry of the ray fan 3.

Of the system for moving and fixing a test object (not shown), only a guide element 7 in the form of a rectilinear rail is shown. The guide element 7 is formed rotatable about a rotational axis 8 formed perpendicular to the plane of projection. The rotational axis 8 is located on the centre axis 5 and outside the connection between focal spot 2 and detector 4. It could however equally be arranged at another point on the centre axis 5, in particular also directly in the focal spot 2 or between focal spot 2 and detector 4. It could thus also be arranged closer to the focal spot 2 or further away from the focal spot 2.

A rotational movement about the rotational axis 8 of the guide element 7 is performed by a rectilinear linear movement along a transverse guide 9. In the embodiment example, the transverse guide 9 is perpendicular to the centre axis 5, but can in principle be arranged at any angle. The connection between transverse guide 9 and guide element 7, in the form of a radial axis, is designed as a tilt-resistant rotational connection which can be freely displaced in radial direction R. A rotation about the rotational axis 8 with the value of the angle of rotation Φ is thus obtained through a simple movement of the centre of rotation 10 along the Cartesian coordinate x.

A test carriage (not shown), such as is known from the state of the art, is movably attached to the guide element 7. It can be fixed in different positions along the guide element 7. This is also known from the state of the art. Since the guide element 7 extends in radial direction R, it is thus possible to move and fix the test carriage in radial direction R in a desired position. Depending on the design and drive means of the test carriage, this can take place continuously—thus at any point in radial direction R—or at discrete points or in steps in radial direction R.

Both the movement of the test carriage in radial direction R along the guide element 7 and the movement of the guide element 7 along the angle of rotation Φ are performed by means of suitable drive devices. The test object is very easily fixed in radial direction R by locking the drive means at the desired point.

Due to the superpositioning of the movement of the test carriage in radial direction R and along the angle of rotation Φ a range of movement 6, in the shape of a slice of cake, is covered by the respective extreme points. In contrast, in the form known from the state of the art a rectangular range of movement 6 is known.

Essentially, the known Cartesian movement of the test carriage has thus been replaced according to the invention by a “polar” movement of the test carriage. A linear transverse track—thus parallel to the Cartesian coordinate x—of the test carriage is also possible without difficulty with the “polar” movement arrangement. This is calculated via the steering of the respective motors which are responsible for the radial movement and for the rotational movement by means of an algorithm designed therefor and adjusted to the geometric conditions of the overall system. For a totally equivalent linear track transverse to the Cartesian movement, such as is known from the state of the art, the test carriage is further provided with a turntable which performs a counter rotation in an object holder and thus of the test object, with the result that this also does not alter its position as regards the angle relative to the ray fan 3.

If the rotational axis 8 (unlike in the embodiment example shown) lies directly in the focal spot 2, the highest degree of accuracy is achieved in its immediate vicinity, but only a short cross-stroke is also achieved. If the rotational axis 8 is brought over the focal spot 2 (thus away from the detector 4) into the position shown in FIG. 2, the cross-stroke is increased at the expense of accuracy. Instead of moving the rotational axis 8, the X-ray source 1 can also be moved in the direction of the detector 4.

A transmission ratio is defined via the distance between rotational axis 8 and transverse guide 9. A large distance between the transverse guide 9 and the rotational axis 8 produces a highly accurate movement of the test carriage near to the rotational axis 8 even when the degree of accuracy of the transverse movement along the Cartesian coordinate x is only moderate.

As a result, the possibility of performing a highly accurate positioning of the test object in the area near to the focal spot is thus obtained by the invention, with a simultaneous low outlay on design and thus lower costs than in the state of the art.

### LIST OF REFERENCE NUMBERS

1 X-ray source
2 Focal spot
3 Ray fan
4 Detector
5 Centre axis
6 Range of movement
7 Guide element
8 Rotational axis
9 Transverse guide
10 Centre of rotation
R Radial direction
x, y Cartesian coordinates
Φ Angle of rotation

1-13. (canceled)

14. A system for moving a test object for a fluoroscopy unit, the system comprising:
a test carriage configured to be fixable to the test object; and
a guide element rotatable about a rotational axis, wherein the test carriage is configured to move along the guide element in a direction extending radially from the rotational axis.

15. The system as recited in claim 14, wherein the rotational axis is disposed at one end of the guide element.

16. The system as recited in claim 14, further comprising a first motor configured to move the test carriage in the radial direction and a second motor configured to rotate the guide element.

17. The system as recited in claim 14, wherein the guide element is a linear unit.

18. The system as recited in claim 14, further comprising a transverse guide cooperating with the guide element and configured to carry out a rotational movement.

19. The system as recited in claim 18, wherein the transverse guide includes a straight guide rail, and further comprising a connecting element disposed on the guide element and movable in a radial direction, wherein the connecting element is configured to engage in the straight guide rail.

20. The system as recited in claim 19, wherein the connecting element is a tilt-resistant rotational connection.

21. A fluoroscopy unit comprising:
an X-ray source having a focal spot;
a detector; and
a system disposed between the X-ray source and the detector and configured to move a test carriage of a fluoroscopy unit, the system including a test carriage configured to be fixable to a test object, and a guide element rotatable about a rotational axis, wherein the test carriage is configured to move along the guide element in a direction extending radially from the rotational axis.

22. The fluoroscopy unit as recited in claim 21, wherein the rotational axis is arranged on a center axis between the focal spot and a center of the detector.

23. The fluoroscopy unit as recited in claim 22, wherein a position of the rotational axis is alterable along a center axis of the detector.

24. The fluoroscopy unit as recited in claim 23, wherein the rotational axis is configured to be shifted along and fixed to a center axis of the detector.

25. The fluoroscopy unit as recited in claim 21, wherein the rotational axis is disposed at the focal spot.

26. The fluoroscopy unit as recited in claim 22, further comprising a transverse guide disposed perpendicularly to a center axis of the detector extending between the focal spot and the center of the detector.

27. The fluoroscopy unit as recited in claim 26, wherein the transverse guide is disposed asymmetrically to the center axis.
